(19) United States
(12) Patent Application Publication
(10) Pub. No.: US 2025/0059941 A1
(43) Pub. Date: Feb. 20, 2025

(54) METHOD AND SYSTEM FOR CLOGGED INJECTORS DIAGNOSTICS USING FUEL TRIMS

(71) Applicant: Intangles Lab Pvt. Ltd., Maharashtra (IN)

(72) Inventors: Aman Singh, Maharashtra (IN); Pushkar Nimkar, Maharashtra (IN); Nikhil Gore, Maharashtra (IN); Neil Unadkat, Maharashtra (IN); Anup Patil, Maharashtra (IN); Jayshri Patil, Karnataka (IN); Abhijit Vishwas Patil, Karnataka (IN); Hariharan Ravishankar, Karnataka (IN); Bhushan Dayaram Patil, Maharashtra (IN); Vikram Reddy Melapudi, Karnataka (IN)

(21) Appl. No.: 18/397,028

(22) Filed: Dec. 27, 2023

(30) Foreign Application Priority Data
Dec. 28, 2022 (IN) 202221076602

(51) Int. Cl. F02M 65/00

(52) U.S. Cl. CPC F02M 65/00

(57) ABSTRACT

Methods and Systems are provided for performing early onset diagnostics for clogged injectors using fuel trims collected from the Engine Management System and evaluated in different operating modes of the engine. Example implementations use fuel trims that can estimate the contrast in combustion ratio λ across different operating modes defined on the engine speed and calculated engine load plane. Features are extracted, then classified using machine learning to output a diagnosis according to different levels of fuel injector clogging.

### CLAIM OF PRIORITY AND RELATED APPLICATIONS

This application claims priority of India Provisional Patent Application No. 202221076602, titled “Method And System For Clogged Injectors Diagnostics Using Fuel Trims,” filed Dec. 28, 2022, the contents of which are incorporated herein by reference in its entirety.

### BACKGROUND

This disclosure relates generally to methods and systems for clogged injector diagnostics using fuel trims. More particularly, methods and system for early onset diagnostics for clogged injectors using fuel trims collected from an engine management system and evaluated in different operating modes of the engine.

In an automobile engine, clogging of the fuel injector can be a result of particulate debris in the fuel. Fuel in the reservoir can inherently carry micro-impurities which can pass through cascading filters and the fuel supply line itself is subject to metal corrosion with the fuel transferring the debris to the injector orifice. In addition to the above, residual gases (fuel fumes and exhaust) in the combustion chamber post crank-off can settle on the injector nozzle and cause restrictions over time. Limited fueling resulting from clogged injectors can manifest in cylinder misfire, lean burn conditions and increased NOx emissions. Irregular NOx emissions can be strong predictors of injector clogging.

The known solutions for tracking irregular NOx emissions include tailpipe emissions tests and On-Board Diagnostic (OBD) monitors. Tailpipe emissions tests entail running the vehicle on a chassis dynamometer, sampling exhausts and an external apparatus to measure concentration of pollutants such as NOx, HC and CO. Though tailpipe emissions tests are extremely sensitive to irregularities in NOx concentration, they cannot serve the purpose of real time monitoring.

The chassis dynamometer-based tailpipe emissions test has multiple drawbacks. The test modes simulated on the dynamometer are found to be inadequate for the lack of frequent low speed-high torque operations observed in real world usage profile. As a result of which, emissions on dynamometer drive cycles are found to be on the lower side as compared to real world conditions. The other more fundamental drawback of tailpipe emissions tests is that they do not serve the purpose of in-use, real time measurement of emissions. The complex apparatus needed to sample and analyze the exhaust cannot be integrated with the chassis.

OBD monitors are limited by their lack of sensitivity to faint irregularities in NOx concentrations and are known to raise alerts only when drivability symptoms begin to show. These monitors comprise software test routines integrated in the vehicle's Engine Management System. There are multiple limitations to using on board monitors for tracking clogged injectors. Firstly, the on-board monitors are unidimensional in design. While they can track an abnormally lean engine by virtue of outlier O2 sensor readings, they are limited in their ability to isolate/diagnose the system causing the leanness. A lean engine can result from leakages in the air intake system apart from fuel line restrictions such as a clogged injector. Secondly, existing on-board monitors lack the sensitivity to track a partially clogged injector. These monitors with unidimensional thresholding on O2 sensor feed can alert against excessively lean running conditions only when multiple injectors are fully clogged. Portable Emissions Measurement Systems (PEMS) have been developed for profiling exhaust emissions in real world usage settings, but their use case is restricted to engineering and development of new powertrain platforms and fuel mixtures. Existing PEMS designs are neither compact nor cost effective to be integrated with production vehicles.

U.S. Pat. No. 5,343,701 discloses an air-fuel ratio control system for an internal combustion engine. In the system, the air-fuel ratio control is performed using a pre stored standard relation between an air-fuel ratio sensor signal and a standard air-fuel ratio indicative value, for deriving the standard air-fuel ratio indicative value based on the sensor signal. This pre-stored characteristic, for-control air-fuel ratio provides high follow-up characteristic of the control as well as the unexpected unevenness or shift in level of the oxygen sensor output is effectively excluded from the air-fuel ratio feedback control. As a result, a highly reliable control performance is ensured to improve exhaust emissions. However, though the prior art air-fuel ratio control system improves the follow-up controllability as described above, the prior art does not provide real time data monitoring and hence does not track the contrast in air-fuel ratio across different operating modes defined on the engine speed and calculated engine load plane.

U.S. Pat. No. 6,155,242 discloses an air/fuel ratio control method for an internal combustion engine. The air/fuel ratio control method corrects airflow prediction errors by comparing the current airflow to the value that was predicted several events in the past and creates an error signal. Based on this error signal, the current fueling is adjusted. The technical advantage of the example implementations described below is the ability to operate the catalytic converter at peak efficiency and the ability to reduce regulated emission. However, the prior art does not provide any solution for diagnosing and/or correcting air/fuel ratios resulting from injector failure.

U.S. Pat. No. 8,135,509 B1 discloses an analysis tool that interfaces with the vehicle's data link connector (DLC) and communicates with the vehicle's powertrain control module (PCM). The tool extracts all the available parameter identifications (i.e., PIDS). These PIDS, which contain information from the inputs and outputs of the powertrain control module, are utilized to make diagnostic decisions to help the technician.

Regulatory emissions frameworks such as Bharat Stage VI in India (comparable with Euro 6) and CAFE 2 (Corporate Average Fuel Efficiency 2) are weighing down on tailpipe emissions for vehicles fitted with Gasoline Direct Injection. The proposed limits on NOx, Carbon Monoxide and unburnt HC emissions are getting tighter along with mandates for in-service conformity. Further, Corporate Average Fuel Efficiency 10 norms aim at lower fuel consumption to achieve the twin goals of reduced CO2 emissions and limiting the consumption of fossil fuels. Fuel injection systems are being fine-tuned for lean charge compositions to get the maximum out of fuel. In such an ecosystem, in-service NOx violations resulting from fuel line restrictions such as injector clogging are a major concern for automotive OEMs.

Therefore, there exists a need for an improved system and methods to track the contrast in combustion ratio (λ) across different operating modes defined on the engine speed and calculated engine load plane. There also exists a need for an improved system and methods for Clogged Injector Diagnostics and ensures heightened sensitivity to injector clogging.

There exists a need for systems and methods for Clogged Injector Diagnostics that ensures heightened sensitivity to injector clogging.

### SUMMARY

In example implementations described in this disclosure, systems and methods are provided for early onset diagnostics for clogged injectors using fuel trims collected from the engine management system and evaluated in different operating modes of the engine.

Example systems and methods provide early onset diagnostics for clogged injectors using fuel trims that can estimate the contrast in combustion ratio λ across different operating modes defined on the engine speed and calculated engine load plane.

### BRIEF DESCRIPTION OF THE FIGURES

FIG. 1 is a schematic diagram illustrating an example of a system for clogged injectors diagnostics using fuel trims.

FIG. 2 is a schematic diagram of the system in FIG. 1 illustrating components in the fuel trim diagnostic system.

FIG. 3A is a flowchart illustrating operation of an example method for performing ‘feature extraction’ for a machine learning model trained to classify health and unhealthy drive cycles.

FIG. 3B is a graph showing fuel trim distribution for a drive-cycle with 6 zones.

FIG. 3C is a graph showing zone-wise reconstruction of fuel trims using bases and weights.

FIG. 4A is a flowchart illustrating operation for collecting labels for a machine learning model trained to classify health and unhealthy drive cycles.

FIG. 4B is a graph showing an example of zones and zone-wise distributions for a healthy label.

FIG. 4C is a graph showing an example of zones and zone-wise distributions for an unhealthy label.

FIG. 5 is a flowchart illustrating operation for a train classifier for a machine learning model trained to classify health and unhealthy drive cycles.

FIG. 6A is a flowchart that represents ‘use classifier’ section of a machine learning model trained to classify health and unhealthy drive cycles, in an example implementation.

FIG. 6B is a graph showing a healthy probability distribution.

### DETAILED DESCRIPTION

The following description with reference to the accompanying drawings is provided to assist in a comprehensive understanding of example implementations of systems and methods for diagnosing clogged fuel injectors using fuel trims. It is to be understood that the implementations described below are examples and that this disclosure is not intended to limit the invention to any example described below.

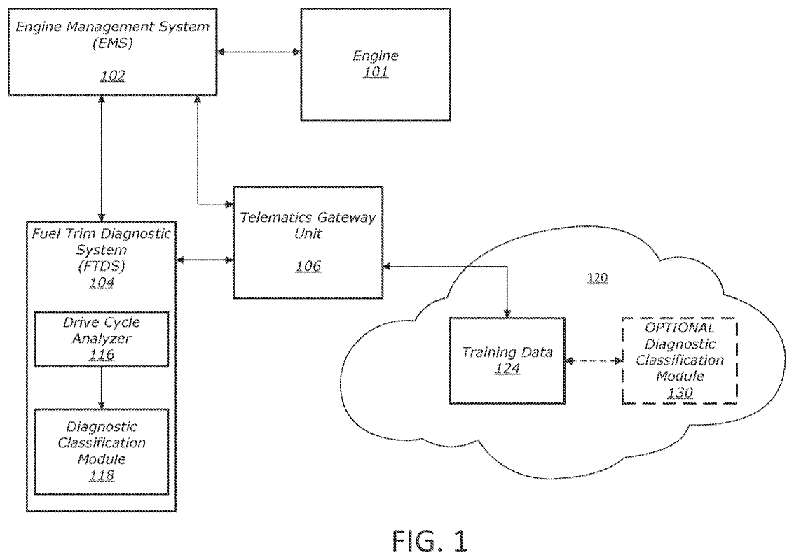

FIG. 1 is a schematic diagram illustrating an example of a system for diagnosing clogged fuel injectors in an internal combustion engine 101. As is known in the art, various performance characteristics may be monitored using sensors mounted on and around the engine 101. The sensors detect different modalities and provide measurements used by an engine management system 102 to calculate various performance parameters. Such sensors may include as examples, sensors for determining long-term and short-term fuel trims, engine load, engine speed, data from oxygen sensors, mass flow air sensors, manifold absolute pressure sensor, fuel pressure sensor, and others that may be relevant to diagnosing fuel injectors.

Fuel trims define adaptations in the pre-calibrated fuel injection maps of engines with electronic fuel injection, based on oxygen saturation in the exhaust. Oxygen saturation is typically measured using a pair of O2 sensors integrated in the exhaust, prior and post the catalytic converter (CATCON). The ideal ratio of air to fuel for complete combustion in a gasoline engine is 14.7:1 and is referred to as λ:1.

Engines may be operated in a fuel rich, or fuel lean mode based on drivability conditions and the demanded torque. Fuel rich conditions imply an air-fuel ratio less than 14.7:1 (λ<1) and are employed when there is an additional need for torque during duty cycles such as acceleration. Rich conditions are described by negative trim values defining a reduction in fueling to sustain λ:1. Fuel lean conditions imply an air-fuel ratio greater than 14.7:1 (λ>1) and are employed at lower engine loads with the objective of optimal/minimal fuel consumption. Lean conditions are described by positive trim values defining a demand for additional fueling to sustain the ideal air-fuel ratio.

In an example implementation, the system includes a fuel trim diagnostic system 104 configured to communicate and exchange information with the engine management system 102. Information exchange may be direct, or via a telematics gateway unit 106. The telematics gateway unit 106 may also access to cloud-based data 120. The fuel trim diagnostic system 104 may include a drive cycle analyzer 116 and a diagnostic classification module 118.

The fuel trim diagnostic system 104 utilizes two trim profiles tracked by the engine management system:
a Long-Term Trim averaged over time and used for additive adaptations at idle to low loads, and
a Short-Term Trim, used for making quick and temporary adaptations at midrange to higher engine loads.

In example implementations, the fuel trim diagnostic system 104 derives an effective fuel trim, which may be defined as an effective adaptation to the base fuel injection pulse. An effective fuel trim may be derived using the parameters defined below as follows:

=>base injection pulse width=IPW

=>long term fuel trim=LTFT(baseline trim: additive)

=>short term fuel trim=STFT(multiplicative trim)

$$\text{=>} long term fuel trim adaptation = LTFT\_ADP = LTFT / 100 + 1$$

$$\text{=>} short term fuel trim adaptation = STFT\_ADP = STFT / 100 + 1$$

$$\text{=>} adapted injection pulse width =$$

$$\text{=>} IPW * ( ( LTFT / 100 + 1 ) * ( STFT / 100 + 1 ) )$$

$$\text{=>} effective trim =$$

$$\text{=>} ( LTFT / 100 + 1 ) * ( STFT / 100 + 1 )$$

$$\text{=>} LTFT\_ADP * STFT\_ADP$$

An alternate, simple, expression of effective trim is:

$$\text{=>} effective trim == ( ( LTFT + STFT ) / 100 + 1 )$$

Example implementations of the fuel trim diagnostic system 104 includes a machine learning module that is trained with previously recorded data from a data sink and is then continuously trained as raw data is collected during the lifetime of the vehicle. An example data sink may be created by operating a specimen vehicle for approximately 160000 Kms in diverse driving conditions including city traffic, low-mid range to high engine load cruise, plethora of altitudes and ambient weather conditions. The specimen vehicle may be equipped with an inline, direct injection, variable valve timing and naturally aspirated gasoline engine. Examples of implementations of the fuel trim diagnostic system 104 may be used with both inline and multi-bank engines with a set of short- and long-term trims per bank. Parameters sampled during the trial include engine speed, calculated engine load, intake manifold air pressure, wheel speed, throttle angle and MIL (Malfunction Indicator Lamp) status. In addition to said telemetry, data from period tailpipe emissions tests is also logged to track anomalous trends in the emission profile of the vehicle. Meteorological data including ambient temperature, pressure and humidity was captured from weather stations in the regions where the trial vehicle was operated.

Excessively high NOx concentrations are observed in the latter half of testing, around an odometer coordinate of 80000 kilometers. Engine telemetry data is evaluated for high-positive/lean trim profile in the vicinity of said odometer coordinate. To isolate fuel line restrictions, specifically clogged injectors, trim profile is correlated against parameters such as intake manifold pressure, throttle angle, MIL status and weather ambient in different operating modes (208, 209). Note the following:
1. It is established that fuel trims are abnormally high at positive fuel enrichment of 10% and above, across multiple operating modes.
2. Leakage in the intake manifold is known to be a common cause of lean burn conditions. Intake manifold pressure data is evaluated at steady idle for positive deviations to isolate a leakage in the air intake circuit. No significant contrast is observed against periods of vehicle operation with ideal trims and normal emissions profile. This nullifies the hypothesis of a leakage in the intake manifold causing the lean burn condition. The same is also validated by an assessment of throttle angle at idle which does not show any significant deviations during operation with anomalous trims and NOx output.
3. Fuel trims are evaluated for deviations at varying operating modes including idle at low load and high load-high speed cruise with engine speeds as high as 3000 rpm during peak acceleration. Positive deviation in fuel trims is found to be amplified at higher engine loads as compared to idle. This justifies a restriction on the fuel supply line. Limited fueling starving the engine at duty cycles with high torque demand, manifests in excessively elevated trims (12.5% to 25%) at high loads in contrast to marginal positive deviation (8.5% to 12.5%) at idle owing to limited fueling requirements at low load.
4. MIL actuation data is correlated with Diagnostic Trouble Codes related to FIP (Fuel Injection Pump), fuel filters, open or shorted injector circuits and cylinder misfire. It is established that lean fuel conditions accompanied by cylinder misfires are not traced to components prior to the injectors.
5. Elevated fuel trims are also correlated with ambient temperatures to ensure drastic changes in ambient are not driving the lean burn conditions. No significant contrast in ambient temperatures is observed against periods of vehicle operation with normal emissions profile.

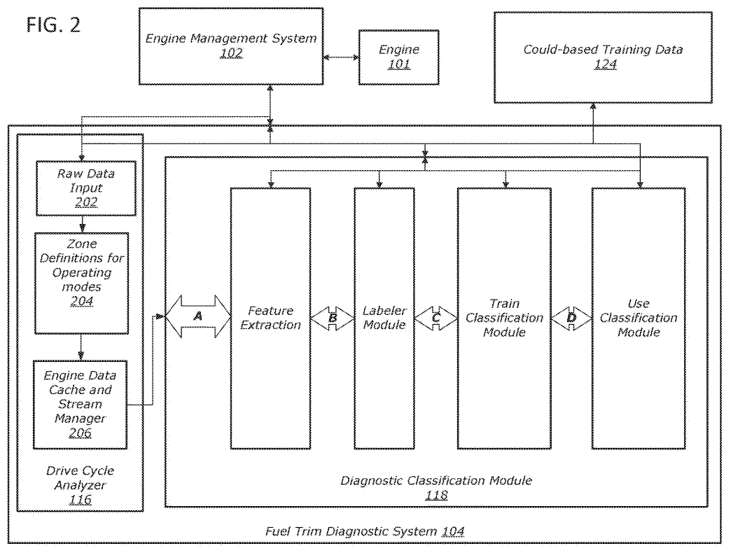

A machine learning model may now be trained to classify healthy and unhealthy driving cycles. In an example implementation, the machine learning model may be implemented using the diagnostic classification module 118. The diagnostic classification module 118 is shown in FIG. 1 as a component of the fuel trim diagnostic system 104. However, the diagnostic classification module 118 may also be integrated in an infotainment system, an engine management system 102 or telematics gateway unit 106. Training data 124 may be stored and updated to a cloud-based data system 120. In other implementations, the diagnostic classification module 130 may be implemented in a cloud-based application as shown in FIG. 1 as an optional implementation. It is noted that the arrangement of modules or units depicted in FIGS. 1 and 2 is an example intended to provide clarity to the description. The modules may be arranged in other ways such as the arrangement described above with respect to the diagnostic classification module 118.

FIG. 2 is a schematic diagram of the system in FIG. 1 illustrating components in the fuel trim diagnostic system 104. The drive cycle analyzer 116 includes a raw data input 202, a program function for defining zones for operating modes 204, and an engine data cache and stream manager 206. The machine learning models implemented in example implementations may be trained using raw data, such as for example, data from the data sink described above for training the models before use, or data collected in real-time as the engine is used. When the engine is in use, the raw data collected in real-time may be collected and represented according to data matrices that may be compared to classifier models to diagnose the condition of the fuel injectors as described with reference to examples below.

The raw data input 202 collects the raw data and the program function for defining zones for operating modes 204 defines zones for organizing the data in a three-dimensional space in zones corresponding to predefined operating modes. The raw data may be streamed from at least one drive cycle in a manner that ensures that sufficient data is collected for each operating mode. The engine data cache and stream manager 206 monitors the streaming of the data and delays the definition of the drive cycle data until the criteria imposed by the zone definitions unit 204 is met.

The diagnostic classification module 118 includes machine learning sections that perform feature extraction on the drive cycle data collected. The machine learning sections in the illustrated example includes:

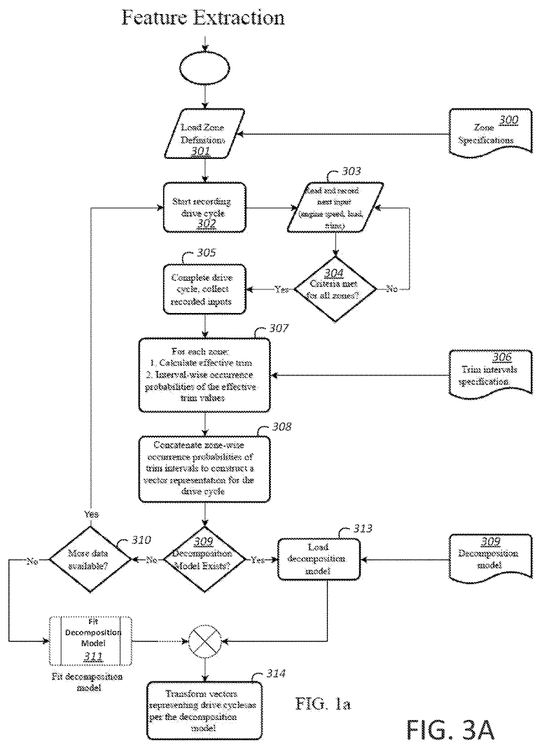

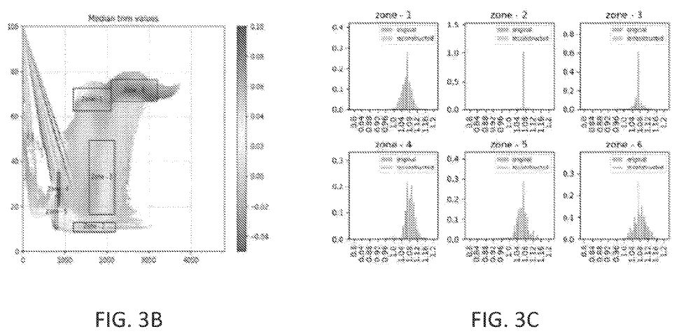

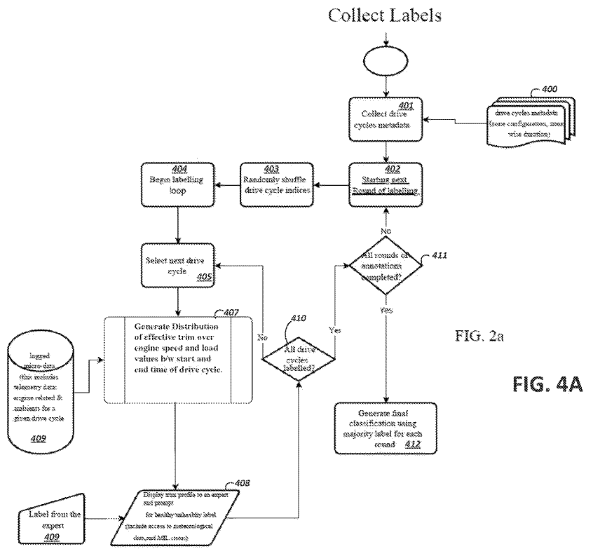

Feature extraction, described with reference to FIGS. 3A-3C.

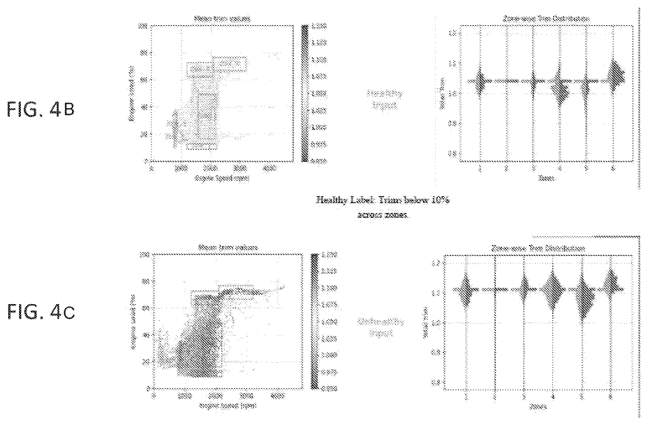

Labeler section, described with reference to FIGS. 4A-4B.

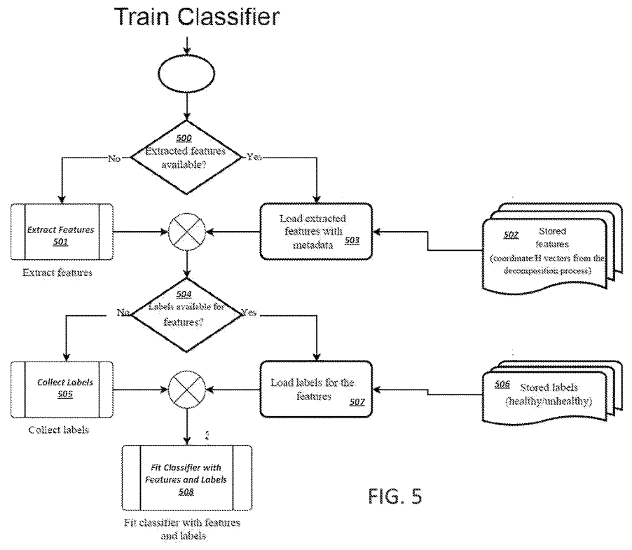

Train classification section, described with reference to FIG. 5

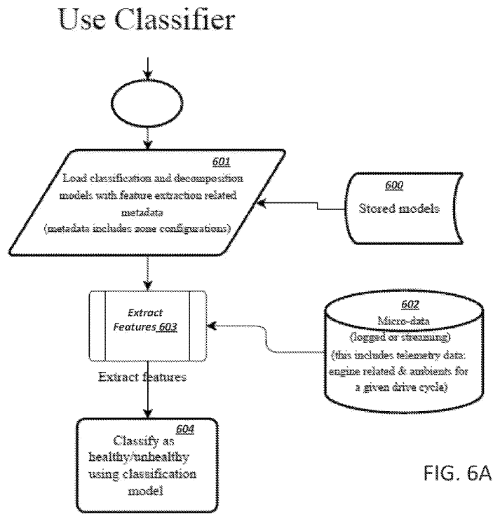

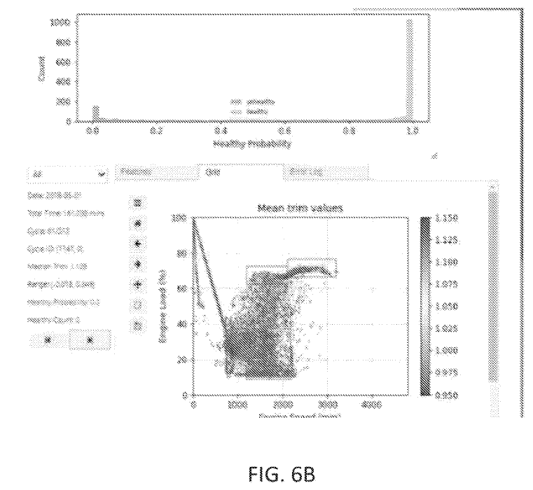

Use classification section, described with reference to FIGS. 6A and 6B.

In example implementations, the feature extraction section in FIG. 2 may receive drive cycle data at A, such as for example, fuel trims, rpm, load, throttle angle, ambients (pressure & temperature), diagnostic error codes for FIS (fuel injection system), geo-spatial data (location, speed)). The feature extraction section may communicate data to the labeler section at B, such as for example, coordinate vectors for drive cycles, which may result from NMF inferencing in the FTDS further resulting in weights for NMF, which may be downloaded and uploaded to and from a cloud data system 120 (in FIG. 1). The labeler section may communicate data with the train classification section at C, such as for example, annotations describing stages of injector clogging. The train classification section may communicate data with the use classification section at D, such as for example, classification model weights.

FIG. 3A is a flowchart illustrating operation of the ‘feature extraction’ section of a machine learning model trained to classify health and unhealthy drive cycles. Examples of the zone definition and operating mode definitions as well as organizing the data into an example 3-D space is also described with reference to FIG. 3A.

A three-dimensional space may be defined with engine speed, calculated engine load and fuel trims. The three-dimensional space is divided into zones 300 using a non-parametric method comprising a priori coordinates of engine speed and calculated engine load. At step 301, the zone definitions are loaded. After loading zone definitions, the zone coordinates are selected to ensure sampling of fuel trims in engine operating modes including and not limited to idle, idle HVAC (Heating, Ventilation, and Air Conditioning), low load cruise, midrange cruise and high load-high engine speed acceleration/cruise. Drive cycles 302, 303 comprising a minimum duration across each zone are sampled from ignition cycles in the trial data set. The minimum duration for zones is based on ensuring optimum support(criteria) at step 304 in fuel trim distributions sampled per zone and maximizing the following ratio:

=>(valid drive cycles)/(ignition cycles)

The above ratio is often referred to as ‘In Use Monitoring Performance Ratio.’ If the criteria are met, then at step 305, all the recorded inputs are collected. It is expected that the fuel trim diagnostic test should execute at least once per ignition cycle considering city driving conditions.

Each engine speed-load zone is represented as a probability distribution at step 307.2 of fuel trims with N continuous bins. So, a given drive cycle with M zones concatenated, is represented as a vector DC_{[N×M]} at step 308. The given vector DC may be flattened into DC_{[(N*M)×1]} given the independent, non-intersecting trim distributions across each of the M zones. Assuming K test cycles extracted from the trial data, a feature matrix V_{[(N*M)×K]} is defined.

In step 309, the method includes checking whether decomposition model exists. If yes, then at step 313, the decomposition model is loaded. If not, then at step 310, more data availability is checked. If data is available, then steps 302 to 309 are repeated, otherwise, the next step 311 is performed.

Feature Matrix V is found to be nonnegative with heavy sparseness as there are multiple fuel trim bins with insignificant to 0 probability. So, V_{[(N*M)× K]} can be approximated using a linear combination of smaller matrices comprising some basis elements and their coordinates (Decomposition). At step 311, assuming R bases, the feature matrix: V_{[(N*×K]} can be approximated as W_{[(N*M)×R]}×H_{[R×K]} i.e., Decomposition model 312). Any drive cycle DC can now be approximated by optimizing the function, DC−WH, i.e., finding the ideal coordinates in H which can help reconstruct the original drive cycle as a linear combination of basis elements in W, with minimal error. At step 314, the drive cycle can now be represented by a coordinate vector H_{[R×1}} representing the weights of bases used to approximate the original drive cycle.

FIG. 3B is a graph showing fuel trim distribution for a drive-cycle with 6 zones. FIG. 3C is a graph showing zone-wise reconstruction of fuel trims using bases and weights.

FIG. 4A is a flowchart illustrating operation for collecting labels for a machine learning model trained to classify health and unhealthy drive cycles. At step 401, the example method includes the step of collecting drive cycles metadata (400) i.e., zone configuration, zone wise duration. Drive cycles collected in the trial are randomly selected into train and test subsets. At 402, the process of labelling drive cycles begins. Unhealthy classification is driven by a distribution positive shift in fuel trims across engine operating modes with a contrast, i.e., increased positive deviation at higher engine modes as compared to lower engine modes. FIG. 2b shows healthy labelling and FIG. 2c shows unhealthy labelling.

At step 403, the method includes randomly shuffling of drive cycle indices to remove human bias. After removing human bias from data collected, at step 404, labelling loop begins. Further, in step 407, the method includes generating distribution of effective trim over engine speed and load values between start and end time of the drive cycle using logged micro data from 406 and selecting the next drive cycles from 405.

At step 408, trim profile is displayed to an expert and a prompt for healthy/unhealthy label (including access to meteorological data, and MIL status) is generated. Then, at step 410, module determines whether all drive cycles are labelled. If yes then at step 412, it generates final classification using the majority label for each round.

FIG. 4B is a graph showing an example of zones and zone-wise distributions for a healthy label.

FIG. 4C is a graph showing an example of zones and zone-wise distributions for an unhealthy label.

FIG. 5 is a flowchart illustrating operation for a train classifier for a machine learning model trained to classify health and unhealthy drive cycles. Extracted features (if available at 500) and stored features 502 i.e., coordinate H vectors from the decomposition process are used to load extracted features with metadata at step 503. At step 504, the method determines whether labels are available for features. If yes, then, at step 507, features are labelled using stored labels 506 i.e., healthy and unhealthy. Back to step 504, if labels are not available then, the method includes collecting labels for features at step 505. At step 508, the R dimensional coordinate vector and the label for the corresponding drive cycle can now be provided as inputs to a classification model.

FIG. 6A is a flowchart that represents ‘use classifier’ section of a machine learning model trained to classify health and unhealthy drive cycles, in an example implementation. Once the models are trained, classifying a run time drive cycle is a two-step process: extracting coordinate vector for drive cycle using decomposition model and then passing coordinate vector as weights to the classification model. At step 601, classification and decomposition models are loaded with features extraction related metadata (metadata includes zone configurations). Now at step 603, coordinate vector is extracted for a drive cycle using decomposition model on micro telemetry data (logged or streaming, engine and ambients included). Any drive cycle at run time can now be decomposed as a combination of W(bases) & H (weights for bases). The coordinate vector H can now be fed to the classification model which outputs an ordered set of severities on an interval scale. These severities may include and are not limited to healthy, marginal clogging, restricted flow and fully clogged. At step 604, drive cycles are labelled healthy and unhealthy using classification model.

Example implementations described herein have been found to be extremely efficacious in early detection of injector clogging. In the trial landscape described above, the example implementation was able to preempt injector clogging up to 15000 KMs prior to tailpipe emissions test failing. The bases and coordinate matrices can be derived using design-validation data in trial phases of the product/vehicle-platform. The classification model can also be trained in the trial phase. Once the bases and coordinate matrices are available and weights for the classification model have been asserted, running model predictions on new drive cycles is found to be computationally light.

FIG. 6B is a graph showing a healthy probability distribution.

Examples of the systems and methods described herein may track the contrast in λ across different operating modes defined on the engine speed and calculated engine load plane. The reconstruction of the original drive cycle using basis elements and coordinate vectors nullifies artifacts and amplifies vital trends in fuel trims against engine operating modes. The drive cycles represented as coordinate vectors with R weights for bases are fed into a classification model which can train on combustive payloads of real-world usage profile data. This ensures heightened sensitivity to injector clogging while the model prediction process continues to be computationally lightweight. This enables integration of example implementations of the systems and methods described herein with cloud-based analytics powered by telematics data as well as modules (including and not limited to modules such as Engine Control Unit, after treatment System, Infotainment System and Body Controller) integrated with the vehicle's data bus.

The art of correlating contrasting λ at high and low engine modes with restriction in the fuel supply line is fundamental to combustion charge stoichiometry. Novelty lies in extracting said contrast as sparse features from vast quantum of real-world usage profile data and training a machine learning model to classify this contrast. The following are not obvious to persons skilled in the art:

Real world usage profile data is found to have abundant artifacts resulting from dynamics such as ambient temperature, pressure, and humidity, driving patterns quantified in velocity−acceleration distributions, traffic conditions and fuel quality. The zone wise fuel trim probability distributions are found to be heavily sparse resulting from limited variance in λ at specific engine modes. Routine traffic conditions on test routes further limit engine duty cycles and diversity in fuel trim profile. The art of factoring a data matrix with N×M dimensions across K test cycles into smaller matrices comprising basis elements and their coordinates, aids in sparse and interpretable feature extraction. Drive cycles are reconstructed using frequent bases which enhances vital trends in trim profile, i.e., the contrast across engine modes. The reduction in feature space also helps with ease of computation.

The art of slicing real world usage data into healthy and unhealthy specimens for training a classification model is also accomplished using examples described herein. Outlier, positive fuel trims can result from afore listed real world dynamics and degradation of components other than dirty injectors. Multiple parameters such as fuel trims on the engine speed—load plane, intake manifold air pressure, throttle angle, ambient temperature and pressure, and Malfunction Indicator Light metadata need to be evaluated parallelly to slice drive cycles with injector clogging while eliminating the bias of an intake manifold leakage, drastic change in weather ambient or a component other than the injector failing in the fuel supply line.

Training a machine learning algorithm to classify drive cycles as unhealthy on an interval scale is innovative to the system. A drive cycle can be characterized with varying intensities of a dirty injector ranging from marginal clogging to complete fuel restriction. The classification model is trained to learn weights in correspondence with the coordinate vectors of basis elements making the model computationally light and easy to interpret.

Routine service and inspection of vehicles can benefit from information on the state of injector clogging. Currently, injector replacement/cleaning on gasoline engines is based on predefined odometer intervals which are estimated during design-validation of the powertrain platform. These numbers can range from 60,000 to 100,000 miles based on territorial fuel composition and quality mandates. The actual clogging rate of the injector in real word usage profile can vary based on a variety of factors such as adulterated fuel at source, fuel reservoir contamination, maintenance of impurity trapping components such as high micron and low micron fuel filters and driving behavior patterns. Aggressive driving encourages wear and tear in the fuel supply line and the corresponding debris advances the rate of clogging.

With real time information on the status of a marginally to partially clogged injector, preemptive maintenance such as cleaning or replacement can help in avoiding events such as frequent misfires and discernible loss in throttle response. In certain cases, with light duty vehicle utilization, the replacement of injectors can be delayed aiding serviceability and reduced maintenance costs.

The example systems and methods described herein can be integrated with simulation software commonly used in engine design and development. With Corporate Average Fuel Efficiency norms, engines are being calibrated for lean burn to deliver maximum fuel economy. Calibration datasets for Engine Management Systems are tested using Simulation Software. These tools take input calibration curves for various actuators in the powertrain, run simulations for a variety of duty cycles, weather, road and traffic conditions, and furnish performance metrics against features such as emissions, FE, thermal profile and acoustics to name a few. While these metrics enable evaluation of emissions distributions specific to engine load/duty modes, the example systems and methods described herein can be embedded in the simulation software to model contrast in emissions across different engine loads. This can prevent overfitting for specific operating modes, leaving gaps in performance in other modes. Engineers may offset tolerances in calibration curves based on impending scenarios such as injector clogging. The example systems and methods described herein can enable the simulation engine to model these adverse scenarios and optimize the offsets.

It is understood that various attributes and elements from any one configuration can also be included in other configurations. Although the present disclosure has been described in detail with reference to certain preferred configurations thereof, other versions are possible. The actual scope of the disclosure encompasses not only the disclosed configurations, but also all equivalent ways of practicing or implementing the disclosure. The above detailed description of the configurations of the disclosure is not intended to be exhaustive or to limit the disclosure to the precise form disclosed above or to the particular field of usage mentioned in this disclosure. While specific configurations of, and examples for, the disclosure are described above for illustrative purposes, various equivalent modifications are possible within the scope of the disclosure, as those skilled in the relevant art will recognize. The elements and acts of the various configurations described above may be combined to provide further configurations. Further, the teachings of the disclosure provided herein may be applied to products and systems other than fuel injector diagnostics.

1. A system for diagnosing a clogged injector of an internal combustion engine comprising:
a data interface configured to receive engine data from an engine management system configured to receive a plurality of parameters from sensors that monitor the parameters indicative of engine operation;
a fuel trim diagnostic system stored as computer programs comprising executable instructions in a memory system; and
a processor configured to execute the executable instructions of the computer programs of the fuel trim diagnostic system, where when executed the fuel diagnostic system maps the plurality of parameters to different levels of fuel injector clogging.

2. The system of claim 1, where the sensors detect modalities to determine the plurality of parameters selected from a list consisting of long-term and short-term fuel trims, engine load, engine speed, data from oxygen sensor, mass flow air sensor, manifold absolute pressure sensor, fuel pressure sensor, and any combination thereof.

3. The system of claim 2, where engine cycle data comprising the long-term and short-term fuel trims, engine load, and engine speed is selected from the plurality of parameters, and the fuel trim diagnostic system includes:
a drive cycle analyzer configured to analyze at least one drive cycle of the engine data to calculate effective fuel trims during time periods in predetermined operation modes of engine operation, and to communicate the effective fuel trims in the predetermined operation modes to the fuel trim diagnostic system as the plurality of parameters to be mapped to the different levels of fuel injector clogging.

4. The system of claim 3, wherein the drive cycle analyzer is configured to calculate the effective fuel trims by receiving a Long time fuel trim (LTFT) and a Short time fuel trim (STFT) from the engine management system and calculating the effective fuel trim as a function of the LTFT and the STFT.

5. The system of claim 4 where the drive cycle analyzer is configured to receive the engine data and cache the engine data for a minimum time period sufficient to operate the engine in each operating mode for a minimum time duration.

6. The system of claim 5 where the fuel trim diagnostic system is configured to:
extract features based on the effective fuel trims in the predetermined zones;
train a classification model using the extracted features obtained from the decomposition model;
extract a coordinate vector for a run-time drive cycle using the decomposition model; and
pass the coordinate vector to the classification model to generate severity data indicative of a level of fuel injector clogging.

7. The system of claim 6 where the memory system comprises a local memory system and a cloud memory system, where the fuel trim diagnostic system is configured to:
store the decomposition model and the classification model in the cloud memory system; and
retrieve the decomposition model and the classification model from the cloud memory to classify engine data received in real-time.

8. The system of claim 6 where the fuel trim diagnostic system extracts features based on the fuel trims in the predetermined zones by:
generating training data by defining a three-dimensional space with engine speed, calculated engine load, and effective fuel trim;
dividing the three-dimensional space into the predetermined operating modes according to coordinates of engine speed and calculated engine load;
configuring a probability distribution for each zone of fuel trims with N continuous bins; and
representing each drive cycle with M zones as a vector DC_{[N×M]}; and defining a feature matrix V_{[(N*M)×K]} based on K test cycles.

9. The system of claim 8 where the fuel trim diagnostic system is configured to train the decomposition model by:
approximating the feature matrix V_{[(N*M)×K]} to train the decomposition model W_{[(N*M)×R]}×H_{[R×K]}, where W is a matrix of elements N*M for R bases and H is a coordinate vector for R bases and K test cycles; and
approximating any drive cycle by optimizing the function DC−WH.

10. The system of claim 9 where the fuel trim diagnostic system is configured to represent any drive cycle by a coordinate vector H[RX1] that approximate an original drive cycle.

11. The system of claim 10 where the fuel trim diagnostic system is configured to:
receive expert annotations on level of injector clogging on all training samples stored in memory unit;
learn a classifier to map set of training samples stored in the memory unit into different clogging levels based on expert annotations.

12. A method for diagnosing a clogged injector of an internal combustion engine having a plurality of sensors for monitoring the engine in communication with an engine management system, the method comprising:
receiving engine data from the engine management system, where the engine data comprises a plurality of parameters from the sensors; and
mapping, by a processor, the plurality of parameters to different levels of fuel injector clogging.

13. The method of claim 12, where the step of receiving the engine data includes receiving the plurality of parameter from sensors configured to detect modalities to determine the plurality of parameters selected from a list consisting of long-term and short-term fuel trims, engine load, engine speed, data from oxygen sensor, mass flow air sensor, manifold absolute pressure sensor, fuel pressure sensor, injector flow rate sensor, and any combination thereof.

14. The method of claim 13, where engine cycle data comprising the long-term and short-term fuel trims, engine load, and engine speed is selected from the plurality of parameters, the method comprising:
analyzing at least one drive cycle of the engine data to calculate effective fuel trims during time periods in predetermined operation modes of engine operation, and
communicating the effective fuel trims in the predetermined operation modes as the plurality of parameters to be mapped to the different levels of fuel injector clogging.

15. The method of claim 14, further comprising:
receiving a Long time fuel trim (LTFT) and a Short time fuel trim (STFT) from the engine management system and
calculating the effective fuel trim as a function of the LTFT and the STFT.

16. The method of claim 15 further comprising:
caching the engine data for a minimum time period sufficient to operate the engine in each operating mode for a minimum time duration.

17. The method of claim 16 further comprising:
extracting features based on the effective fuel trims in the predetermined zones;
train a classification model using the extracted features obtained from the decomposition model;
extracting a coordinate vector for a run-time drive cycle using the decomposition model; and
passing the coordinate vector to the classification model to generate severity data indicative of a level of fuel injector clogging.

18. The method of claim 17 further comprising:
storing the decomposition model and the classification model in the cloud memory system; and
retrieving the decomposition model and the classification model from the cloud memory to classify engine data received in real-time.

19. The method of claim 18 further comprising:
generating training data by defining a three-dimensional space with engine speed, calculated engine load, and effective fuel trim;
dividing the three-dimensional space into the predetermined operating modes according to coordinates of engine speed and calculated engine load;
configuring a probability distribution for each zone of fuel trims with N continuous bins; and
representing each drive cycle with M zones as a vector DC_{[N×M]}; and defining a feature matrix V_{[(N*M)×K]} based on K test cycles.

20. The method of claim 19 further comprising:
approximating the feature matrix V_{[(N*M)×K]} to train the decomposition model W_{[(N*M)×R]}×H_{[R×K]}, where W is a matrix of elements N*M for R bases and H is a coordinate vector for R bases and K test cycles; and
approximating any drive cycle by optimizing the function DC−WH.

21. The method of claim 20 further comprising:
receiving expert annotations on level of injector clogging on all training samples stored in memory unit;
learning a classifier to map set of training samples stored in the memory unit into different clogging levels based on expert annotations.
